(19) United States
(12) Patent Application Publication
(10) Pub. No.: US 2023/0297232 A1
(43) Pub. Date: Sep. 21, 2023

(54) TABLE SORTING METHOD, MEMORY STORAGE DEVICE, AND MEMORY CONTROL CIRCUIT UNIT

(71) Applicant: Hefei Core Storage Electronic Limited, Anhui (CN)

(72) Inventors: Chih-Ling Wang, Anhui (CN); Qi-Ao Zhu, Anhui (CN); Jing Zhang, Anhui (CN); Jian Hu, Anhui (CN)

(73) Assignee: Hefei Core Storage Electronic Limited, Anhui (CN)

(21) Appl. No.: 17/717,168

(22) Filed: Apr. 11, 2022

(30) Foreign Application Priority Data
Mar. 18, 2022 (CN) 202210269910.4

(51) Int. Cl. G06F 3/06

(52) U.S. Cl. CPC G06F 3/0604; G06F 3/0655; G06F 3/0679

(57) ABSTRACT

A table sorting method, a memory storage device, and a memory control circuit unit are provided. The method includes: reading first data from a first physical unit by using a first read voltage level according to a first voltage management table among multiple voltage management tables; decoding the first data; in response to the first data being successfully decoded, updating count information corresponding to the first voltage management table; and in response to the count information meeting a default condition, increasing a usage priority of the first voltage management table among the voltage management tables.

### CROSS-REFERENCE TO RELATED APPLICATION

This application claims the priority benefit of China application serial no. 202210269910.4, filed on Mar. 18, 2022. The entirety of the above-mentioned patent application is hereby incorporated by reference herein and made a part of this specification.

### BACKGROUND

### Technical Field

The disclosure relates to a memory management technology, and more particularly to a table sorting method, a memory storage device, and a memory control circuit unit.

### Description of Related Art

Smartphones, tablet computers, and notebook computers have grown rapidly in recent years, resulting in a rapid increase in consumer demand for storage media. Since the rewritable non-volatile memory module (for example, a flash memory) has characteristics such as non-volatile data, power saving, small size, and no mechanical structure, the rewritable non-volatile memory module is very suitable to be built into various portable multimedia devices exemplified above.

Generally, data is encoded before being stored in the rewritable non-volatile memory module. When the data is to be read, the read data may be decoded to attempt to correct errors therein. In addition, the setting of the read voltage level for reading the data also has a great influence on the accuracy of the read data. Generally, multiple management tables may be stored in the rewritable non-volatile memory module. When the data is to be read, the management tables may be queried according to a default sequence to determine the read voltage level used for the current reading according to the information in the management table sorted first among the management tables. If the data read by using the read voltage level cannot be correctly decoded, the information in the next management table sorted after the management table may be queried to determine the read voltage level used for the next reading. However, sequentially querying the management tables according to the default sequence may cause the data decoding efficiency to decrease due to changes in the threshold voltage distribution of memory cells in the rewritable non-volatile memory module.

### SUMMARY

The disclosure provides a table sorting method, a memory storage device, and a memory control circuit unit, which can increase decoding efficiency.

An exemplary embodiment of the disclosure provides a table sorting method, which is used for a rewritable non-volatile memory module. The rewritable non-volatile memory module includes multiple physical units. The table sorting method includes the following steps. First data is read from a first physical unit among the physical units by using a first read voltage level according to a first voltage management table among multiple voltage management tables. The first data is decoded. In response to the first data being successfully decoded, count information corresponding to the first voltage management table is updated. In response to the count information meeting a default condition, a usage priority of the first voltage management table among the voltage management tables is increased.

An exemplary embodiment of the disclosure further provides a memory storage device, which includes a connection interface unit, a rewritable non-volatile memory module, and a memory control circuit unit. The connection interface unit is used to couple to a host system. The rewritable non-volatile memory module includes multiple physical units. The memory control circuit unit is coupled to the connection interface unit and the rewritable non-volatile memory module. The memory control circuit unit is used to execute the following steps. First data is read from a first physical unit among the physical units by using a first read voltage level according to a first voltage management table among multiple voltage management tables. The first data is decoded. In response to the first data being successfully decoded, count information corresponding to the first voltage management table is updated. In response to the count information meeting a default condition, a usage priority of the first voltage management table among the voltage management tables is increased.

An exemplary embodiment of the disclosure further provides a memory control circuit unit, which includes a host interface, a memory interface, a decoding circuit, and a memory management circuit. The host interface is used to couple to a host system. The memory interface is used to couple to the rewritable non-volatile memory module. The rewritable non-volatile memory module includes multiple physical units. The memory management circuit is coupled to the host interface, the memory interface, and the decoding circuit. The memory management circuit is used to read first data from a first physical unit among the physical units by using a first read voltage level according to a first voltage management table among multiple voltage management tables. The decoding circuit is used to decode the first data. In response to the first data being successfully decoded, the memory management circuit is further used to update count information corresponding to the first voltage management table. In response to the count information meeting a default condition, the memory management circuit is further used to increase a usage priority of the first voltage management table among the voltage management tables.

Based on the above, after reading the first data from the first physical unit by using the first read voltage level according to the first voltage management table, the first data may be decoded. In response to the first data being successfully decoded, the count information corresponding to the first voltage management table may be updated. In particular, in response to the count information meeting the default condition, the usage priority of the first voltage management table among the voltage management tables may be increased. Thereby, decoding efficiency of executing a decoding operation by using the voltage management tables in the future can be increased.

### BRIEF DESCRIPTION OF THE DRAWINGS

FIG. 1 is a schematic diagram of a host system, a memory storage device, and an input/output (I/O) device according to an exemplary embodiment of the disclosure.

FIG. 2 is a schematic diagram of a host system, a memory storage device, and an I/O device according to an exemplary embodiment of the disclosure.

FIG. 3 is a schematic diagram of a host system and a memory storage device according to an exemplary embodiment of the disclosure.

FIG. 4 is a schematic diagram of a memory storage device according to an exemplary embodiment of the disclosure.

FIG. 5 is a schematic diagram of a memory control circuit unit according to an exemplary embodiment of the disclosure.

FIG. 6 is a schematic diagram of managing a rewritable non-volatile memory module according to an exemplary embodiment of the disclosure.

FIG. 7 is a schematic diagram of a management table and a usage sequence thereof according to an exemplary embodiment of the disclosure.

FIG. 8 is a schematic diagram of reading data by sequentially using different read voltage levels in a decoding operation according to an exemplary embodiment of the disclosure.

FIG. 9 is a schematic diagram of increasing a usage priority of a first voltage management table among multiple voltage management tables according to an exemplary embodiment of the disclosure.

FIG. 10 is a flowchart of a table sorting method according to an exemplary embodiment of the disclosure.

### DETAILED DESCRIPTION OF DISCLOSED EMBODIMENTS

Generally speaking, a memory storage device (also referred to as a memory storage system) includes a rewritable non-volatile memory module and a controller (also referred to as a control circuit). The memory storage device may be used together with a host system, so that the host system may write data into the memory storage device or read data from the memory storage device.

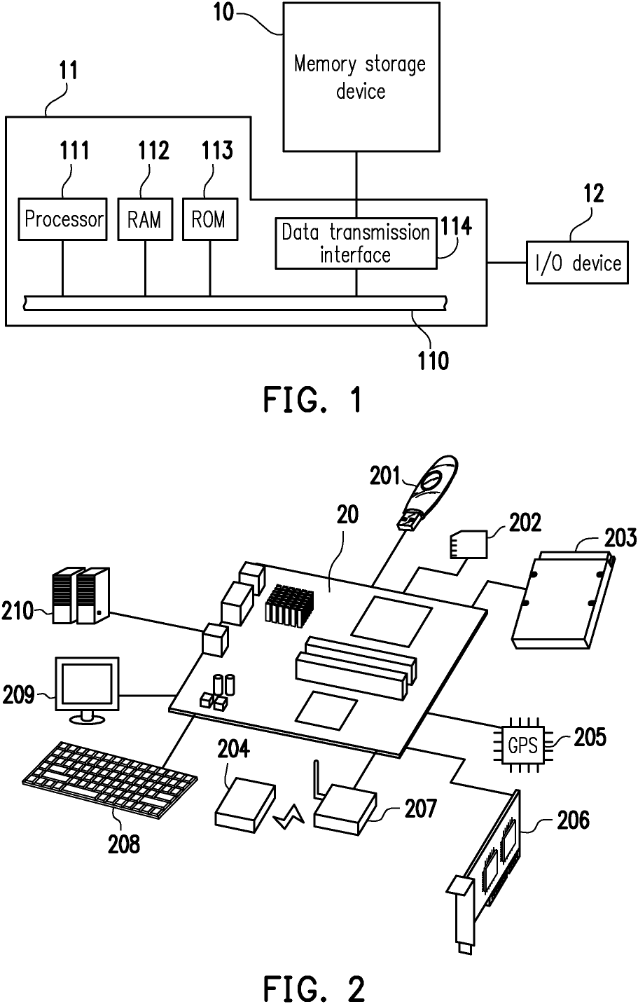

FIG. 1 is a schematic diagram of a host system, a memory storage device, and an input/output (I/O) device according to an exemplary embodiment of the disclosure. FIG. 2 is a schematic diagram of a host system, a memory storage device, and an I/O device according to an exemplary embodiment of the disclosure.

Please refer to FIG. 1 and FIG. 2. A host system 11 may include a processor 111, a random access memory (RAM) 112, a read only memory (ROM) 113, and a data transmission interface 114. The processor 111, the random access memory 112, the read only memory 113, and the data transmission interface 114 are all coupled to a system bus 110.

In an exemplary embodiment, the host system 11 may be coupled to the memory storage device 10 through the data transmission interface 114. For example, the host system 11 may store data to the memory storage device 10 or read data from the memory storage device 10 via the data transmission interface 114. In addition, the host system 11 may be coupled to the I/O device 12 through the system bus 110. For example, the host system 11 may send an output signal to the I/O device 12 or receive an input signal from the I/O device 12 via the system bus 110.

In an exemplary embodiment, the processor 111, the random access memory 112, the read only memory 113, and the data transmission interface 114 may be disposed on a motherboard 20 of the host system 11. The number of the data transmission interface 114 may be one or more. Through the data transmission interface 114, the motherboard 20 may be coupled to the memory storage device 10 via a wired or wireless manner.

In an exemplary embodiment, the memory storage device 10 may, for example, be a flash drive 201, a memory card 202, a solid state drive (SSD) 203, or a wireless memory storage device 204. The wireless memory storage device 204 may, for example, be a near field communication (NFC) memory storage device, a WiFi memory storage device, a Bluetooth memory storage device, a low-power Bluetooth memory storage device (for example, iBeacon), or other memory storage devices based on various wireless communication technologies. In addition, the motherboard 20 may also be coupled to a global positioning system (GPS) module 205, a network interface card 206, a wireless transmission device 207, a keyboard 208, a screen 209, a speaker 210, or various other I/O devices through the system bus 110. For example, in an exemplary embodiment, the motherboard 20 may access the wireless memory storage device 204 through the wireless transmission device 207.

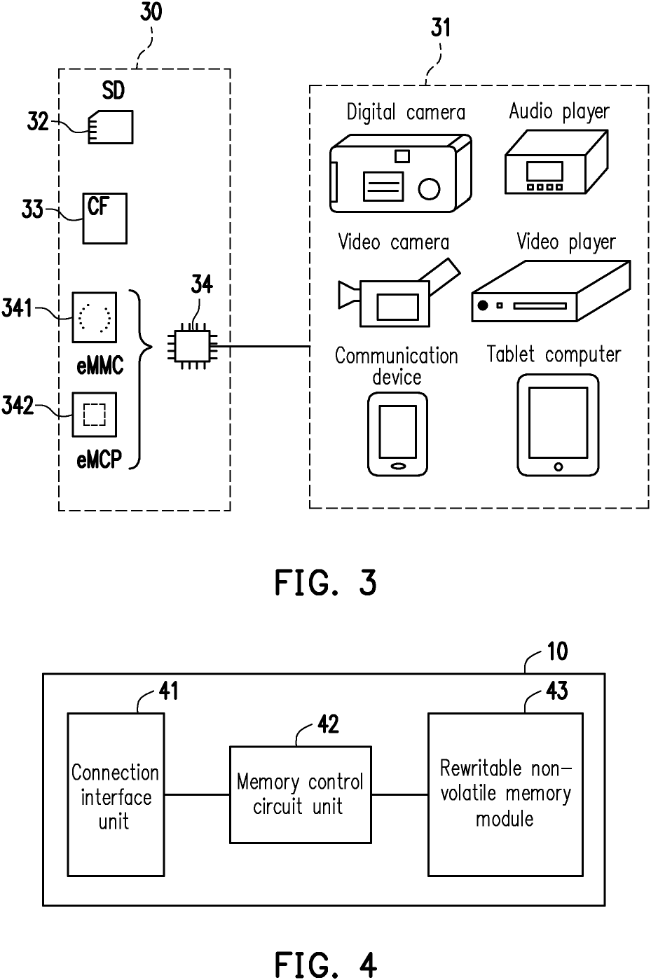

In an exemplary embodiment, the host system 11 is a computer system. In an exemplary embodiment, the host system 11 may be substantially any system that may cooperate with a memory storage device to store data. In an exemplary embodiment, the memory storage device 10 and the host system 11 may respectively include a memory storage device 30 and a host system 31 of FIG. 3.

FIG. 3 is a schematic diagram of a host system and a memory storage device according to an exemplary embodiment of the disclosure. Please refer to FIG. 3. The memory storage device 30 may be used in conjunction with the host system 31 to store data. For example, the host system 31 may be a digital camera, video camera, communication device, audio player, video player or tablet computer system. For example, the memory storage device 30 may be a secure digital (SD) card 32, a compact flash (CF) card 33, an embedded storage device 34, or various other non-volatile memory storage devices used by the host system 31. The embedded storage device 34 includes an embedded multi media card (eMMC) 341, an embedded multi chip package (eMCP) storage device 342, and/or various other embedded storage devices in which a memory module is directly coupled onto a substrate of a host system.

FIG. 4 is a schematic diagram of a memory storage device according to an exemplary embodiment of the disclosure. Please refer to FIG. 4. The memory storage device 10 includes a connection interface unit 41, a memory control circuit unit 42, and a rewritable non-volatile memory module 43.

The connection interface unit 41 is used to couple the memory storage device 10 to the host system 11. The memory storage device 10 may communicate with the host system 11 via the connection interface unit 41. In an exemplary embodiment, the connection interface unit 41 is compatible with the peripheral component interconnect express (PCI express) standard. In an exemplary embodiment, the connection interface unit 41 may also conform to the serial advanced technology attachment (SATA) standard, the parallel advanced technology attachment (PATA) standard, the Institute of Electrical and Electronic Engineers (IEEE) 1394 standard, the universal serial bus (USB) standard, the SD interface standard, the ultra high speed-I (UHS-I) interface standard, the ultra high speed-II (UHS-II) interface standard, the memory stick (MS) interface standard, the MCP interface standard, the MMC interface standard, the eMMC interface standard, the universal flash storage (UFS) interface standard, the eMCP interface standard, the CF interface standard, the integrated device electronics (IDE) standard, or other suitable standards. The connection interface unit 41 may be packaged in one chip with the memory control circuit unit 42, or the connection interface unit 41 may be arranged outside a chip containing the memory control circuit unit 42.

The memory control circuit unit 42 is coupled to the connection interface unit 41 and the rewritable non-volatile memory module 43. The memory control circuit unit 42 is used to execute multiple logic gates or control commands implemented in the form of hardware or the form of firmware and perform operations such as data writing, reading, and erasing in the rewritable non-volatile memory module 43 according to a command of the host system 11.

The rewritable non-volatile memory module 43 is used to store data written by the host system 11. The rewritable non-volatile memory module 43 may include a single level cell (SLC) NAND flash memory module (that is, a flash memory module that may store 1 bit in one memory cell), a multi level cell (MLC) NAND flash memory module (that is, a flash memory module that may store 2 bits in one memory cell), a triple level cell (TLC) NAND flash memory module (that is, a flash memory module that may store 3 bits in one memory cell), a quad level cell (QLC) NAND flash memory module (that is, a flash memory module that may store 4 bits in one memory cell), other flash memory modules, or other memory modules with the same characteristics.

Each memory cell in the rewritable non-volatile memory module 43 stores one or more bits with changes in voltage (hereinafter also referred to as a threshold voltage). Specifically, there is a charge trapping layer between a control gate and a channel of each memory cell. Through applying a write voltage to the control gate, the number of electrons in the charge trapping layer may be changed, thereby changing the threshold voltage of the memory cell. The operation of changing the threshold voltage of the memory cell is also referred to as “writing data into the memory cell” or “programming the memory cell”. As the threshold voltage changes, each memory cell in the rewritable non-volatile memory module 43 has multiple storage states. Through applying a read voltage, it is possible to judge which storage state a memory cell belongs to, thereby obtaining one or more bits stored in the memory cell.

In an exemplary embodiment, memory cells of the rewritable non-volatile memory module 43 may constitute multiple physical programming units, and the physical programming units may constitute multiple physical erasing units. Specifically, the memory cells on the same word line may form one or more physical programming units. If each memory cell may store more than 2 bits, the physical programming units on the same word line may be classified into at least a lower physical programming unit and an upper physical programming unit. For example, a least significant bit (LSB) of a memory cell belongs to the lower physical programming unit, and a most significant bit (MSB) of a memory cell belongs to the upper physical programming unit. Generally speaking, in the MLC NAND flash memory, the write speed of the lower physical programming unit is greater than the write speed of the upper physical programming unit, and/or the reliability of the lower physical programming unit is higher than the reliability of the upper physical programming unit.

In an exemplary embodiment, the physical programming unit is the smallest unit of programming. That is, the physical programming unit is the smallest unit of writing data. For example, the physical programming unit may be a physical page or a physical sector. If the physical programming unit is a physical page, the physical programming units may include a data bit area and a redundancy bit area. The data bit area contains multiple physical sectors for storing user data, and the redundancy bit area is used to store system data (for example, management data such as an error correcting code). In an exemplary embodiment, the data bit area contains 32 physical sectors, and the size of one physical sector is 512 bytes (B). However, in other exemplary embodiments, the data bit area may also contain 8, 16, more, or less physical sectors, and the size of each physical sector may also be greater or smaller. On the other hand, the physical erasing unit is the smallest unit of erasure. That is, each physical erasing unit contains the smallest number of memory cells to be erased together. For example, the physical erasing unit is a physical block.

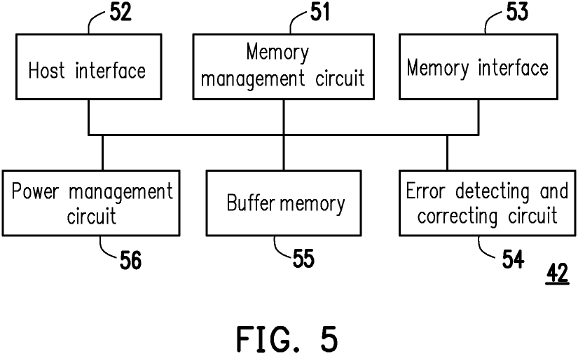

FIG. 5 is a schematic diagram of a memory control circuit unit according to an exemplary embodiment of the disclosure. Please refer to FIG. 5. The memory control circuit unit 42 includes a memory management circuit 51, a host interface 52, a memory interface 53, and an error detecting and correcting circuit 54.

The memory management circuit 51 is used to control the overall operation of the memory control circuit unit 42. Specifically, the memory management circuit 51 has multiple control commands, and when the memory storage device 10 is operating, the control commands are executed to perform operations such as data writing, reading, and erasing. The following description of the operation of the memory management circuit 51 is equivalent to the description of the operation of the memory control circuit unit 42.

In an exemplary embodiment, the control commands of the memory management circuit 51 are implemented in the form of firmware. For example, the memory management circuit 51 has a microprocessor unit (not shown) and a read only memory (not shown), and the control commands are burnt into the read only memory. When the memory storage device 10 is operating, the control commands are executed by the microprocessor unit to perform operations such as data writing, reading, and erasing.

In an exemplary embodiment, the control commands of the memory management circuit 51 may also be stored to a specific area (for example, a system area dedicated to storing system data in a memory module) of the rewritable non-volatile memory module 43 in the form of program codes. In addition, the memory management circuit 51 has a microprocessor unit (not shown), a read only memory (not shown), and a random access memory (not shown). In particular, the read only memory has a boot code, and when the memory control circuit unit 42 is enabled, the microprocessor unit first executes the boot code to load the control commands stored in the rewritable non-volatile memory module 43 to the random access memory of the memory management circuit 51. After that, the microprocessor unit runs the control commands to perform operations such as data writing, reading, and erasing.

In an exemplary embodiment, the control commands of the memory management circuit 51 may also be implemented in the form of hardware. For example, the memory management circuit 51 includes a microcontroller, a memory cell management circuit, a memory write circuit, a memory read circuit, a memory erase circuit, and a data processing circuit. The memory cell management circuit, the memory write circuit, the memory read circuit, the memory erase circuit, and the data processing circuit are coupled to the microcontroller. The memory cell management circuit is used to manage a memory cell or a memory cell group of the rewritable non-volatile memory module 43. The memory write circuit is used to issue a write command sequence to the rewritable non-volatile memory module 43 to write data into the rewritable non-volatile memory module 43. The memory read circuit is used to issue a read command sequence to the rewritable non-volatile memory module 43 to read data from the rewritable non-volatile memory module 43. The memory erase circuit is used to issue an erase command sequence to the rewritable non-volatile memory module 43 to erase data from the rewritable non-volatile memory module 43. The data processing circuit is used to process data to be written into the rewritable non-volatile memory module 43 and data read from the rewritable non-volatile memory module 43. The write command sequence, the read command sequence, and the erase command sequence may each include one or more program codes or command codes and are used to instruct the rewritable non-volatile memory module 43 to execute corresponding operations such as writing, reading, and erasing. In an exemplary embodiment, the memory management circuit 51 may also issue other types of command sequences to the rewritable non-volatile memory module 43 to instruct to execute corresponding operations.

The host interface 52 is coupled to the memory management circuit 51. The memory management circuit 51 may communicate with the host system 11 through the host interface 52. The host interface 52 may be used to receive and identify commands and data sent by the host system 11. For example, the commands and the data sent by the host system 11 may be sent to the memory management circuit 51 through the host interface 52. In addition, the memory management circuit 51 may send data to the host system 11 through the host interface 52. In the exemplary embodiment, the host interface 52 is compatible with the PCI express standard. However, it must be understood that the disclosure is not limited thereto. The host interface 52 may also be compatible with the SATA standard, the PATA standard, the IEEE 1394 standard, the USB standard, the SD standard, the UHS-I standard, the UHS-II standard, the MS standard, the MMC standard, the eMMC standard, the UFS standard, the CF standard, the IDE standard, or other suitable data transmission standards.

The memory interface 53 is coupled to the memory management circuit 51 and is used to access the rewritable non-volatile memory module 43. For example, the memory management circuit 51 may access the rewritable non-volatile memory module 43 through the memory interface 53. In other words, the data to be written into the rewritable non-volatile memory module 43 is converted into a format acceptable by the rewritable non-volatile memory module 43 via the memory interface 53. Specifically, if the memory management circuit 51 intends to access the rewritable non-volatile memory module 43, the memory interface 53 will send the corresponding command sequence. For example, the command sequences may include the write command sequence instructing to write data, the read command sequence instructing to read data, the erase command sequence instructing to erase data, and corresponding command sequences instructing various memory operations (for example, changing a read voltage level, executing a garbage collection operation, etc.). The command sequences are, for example, generated by the memory management circuit 51 and sent to the rewritable non-volatile memory module 43 through the memory interface 53. The command sequences may include one or more signals, or data on a bus. The signals or the data may include command codes or program codes. For example, the read command sequence includes information such as a read recognition code and memory address.

The error detecting and correcting circuit (also referred to as a decoding circuit) 54 is coupled to the memory management circuit 51 and is used to execute error detecting and correcting operations to ensure the correctness of the data. Specifically, when the memory management circuit 51 receives a write command from the host system 11, the error detecting and correcting circuit 54 generates a corresponding error correcting code (ECC) and/or error detecting code (EDC) for the data corresponding to the write command, and the memory management circuit 51 writes the data corresponding to the write command and the corresponding error correcting code and/or error checking code into the rewritable non-volatile in memory module 43. After that, when the memory management circuit 51 reads the data from the rewritable non-volatile memory module 43, the error correcting code and/or the error detecting code corresponding to the data is simultaneously read, and the error detecting and correcting circuit 54 executes the error detecting and correcting operations on the read data according to the error correcting code and/or the error detecting code.

In an exemplary embodiment, the memory control circuit unit 42 further includes a buffer memory 55 and a power management circuit 56.

The buffer memory 55 is coupled to the memory management circuit 51 and is used to temporarily store data. The power management circuit 56 is coupled to the memory management circuit 51 and is used to control the power of the memory storage device 10.

In an exemplary embodiment, the rewritable non-volatile memory module 43 of FIG. 4 may include a flash memory module. In an exemplary embodiment, the memory control circuit unit 42 of FIG. 4 may include a flash memory controller. In an exemplary embodiment, the memory management circuit 51 of FIG. 5 may include a flash memory management circuit.

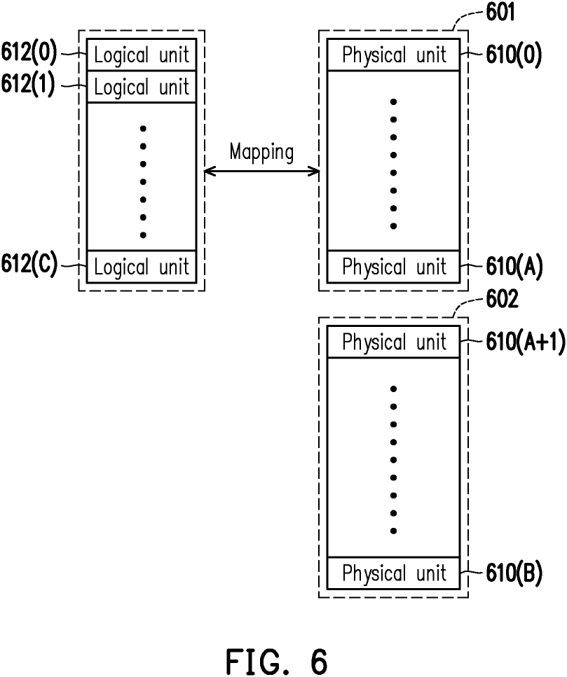

FIG. 6 is a schematic diagram of managing a rewritable non-volatile memory module according to an exemplary embodiment of the disclosure. Please refer to FIG. 6. The memory management circuit 51 may logically group physical units 610(0) to 610(B) in the rewritable non-volatile memory module 43 into a storage area 601 and a spare area 602.

In an exemplary embodiment, a physical unit refers to a physical address or a physical programming unit. In an exemplary embodiment, a physical unit may also be composed of multiple continuous or discontinuous physical addresses. In an exemplary embodiment, a physical unit may also refer to a virtual block (VB). A virtual block may include multiple physical addresses or multiple physical programming units.

The physical units 610(0) to 610(A) in the storage area 601 are used to store the user data (for example, the user data from the host system 11 of FIG. 1). For example, the physical units 610(0) to 610(A) in the storage area 601 may store valid data and invalid data. The physical units 610(A+1) to 610(B) in the spare area 602 do not store data (for example, valid data). For example, if a certain physical unit does not store valid data, the physical unit may be associated (or added) to the spare area 602. In addition, the physical units (or the physical units that do not store valid data) in the spare area 602 may be erased. When writing new data, one or more physical units may be extracted from the spare area 602 to store the new data. In an exemplary embodiment, the spare area 602 is also referred to as a free pool.

The memory management circuit 51 may be configured with logical units 612(0) to 612(C) to map the physical units 610(0) to 610(A) in the storage area 601. In an exemplary embodiment, each logical unit corresponds to one logical address. For example, a logical address may include one or more logical block addresses (LBA) or other logical management units. In an exemplary embodiment, a logical unit may also correspond to one logical programming unit or consist of multiple continuous or discontinuous logical addresses.

It should be noted that one logical unit may be mapped to one or more physical units. If a certain physical unit is currently mapped by a certain logical unit, it means that data currently stored in the physical unit includes valid data. Conversely, if a certain physical unit is not currently mapped by any logical unit, it means that data currently stored in the physical unit is invalid data.

The memory management circuit 51 may record management data (also referred to as logical-to-physical mapping information) describing a mapping relationship between the logical unit and the physical unit in at least one logical-to-physical mapping table. When the host system 11 intends to read data from the memory storage device 10 or write data into the memory storage device 10, the memory management circuit 51 may access the rewritable non-volatile memory module 43 according to the information in the logical-to-physical mapping table.

In an exemplary embodiment, the memory management circuit 51 may store multiple management tables in the rewritable non-volatile memory module 43 (for example, in a system area dedicated to storing system information). The information in the management table may be used to determine the read voltage level. For example, the management table may record a voltage offset value. The voltage offset value may be used to adjust a reference voltage level to obtain the read voltage level to be used. The determined read voltage level may be used to read the physical unit in the storage area 601 to obtain data stored in the physical unit.

In an exemplary embodiment, the error detecting and correcting circuit 54 may execute a decoding operation on the data read from physical unit to attempt to correct error bits in the data. For example, the error detecting and correcting circuit 54 may support various encoding/decoding algorithms such as a low density parity check (LDPC) code or BCH. If a certain decoding operation may successfully decode certain data, the successfully decoded data may be output, for example, sent to the host system 10 to respond to a read request of the host system 10. However, if a certain decoding operation cannot successfully decode certain data, the memory management circuit 51 may use a different read voltage level to read a first physical unit again to attempt to reduce the error bits in the read data and/or increase a decoding success rate of the read data. Thereafter, the error detecting and correcting circuit 54 may decode the read data again.

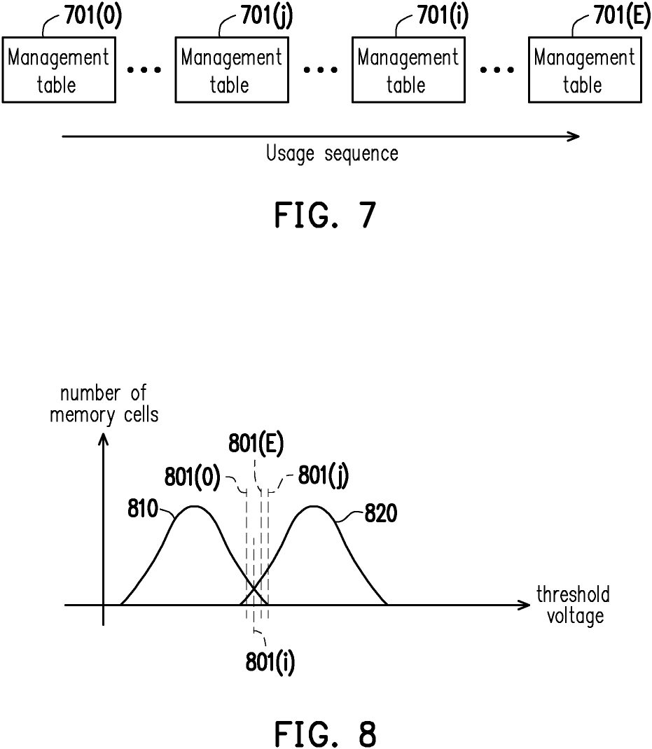

FIG. 7 is a schematic diagram of a management table and a usage sequence thereof according to an exemplary embodiment of the disclosure. FIG. 8 is a schematic diagram of reading data by sequentially using different read voltage levels in a decoding operation according to an exemplary embodiment of the disclosure.

Please refer to FIG. 7. Management tables (also referred to as voltage management tables) 701(0) to 701(E) may be stored in the rewritable non-volatile memory module 43. Information in the management tables 701(0) to 701(E) may be respectively used to determine read voltage levels 801(0) to 801(E) in FIG. 8. For example, the information in the management table 701(0) may be used to determine the read voltage level 801(0), the information in the management table 701(j) may be used to determine the read voltage level 801(j), the information in the management table 701(i) may be used to determine the read voltage level 801(i), and the information in the management table 701(E) may be used to determine the read voltage level 801(E), where i and j are positive integers greater than 0 and less than E, and i is not equal to j.

It should be noted that in the decoding operation for data read from the same physical unit, a usage sequence of the management tables 701(0) to 701(E) is as shown in FIG. 7. For example, the usage sequence may reflect that a usage priority of the management table 701(0) is higher than a usage priority of the management table 701(j), the usage priority of the management table 701(j) is higher than a usage priority of the management table 701(i), and the usage priority of the management table 701(i) is higher than a usage priority of the management table 701(E). In addition, information of the usage sequence of the management tables 701(0) to 701(E) may be recorded in sorting information. The sorting information may also be stored in the rewritable non-volatile memory module 43. The sorting information may reflect the usage sequence of the management tables 701(0) to 701(E) in the decoding operation.

Please refer to FIG. 8. When data is to be read from a certain physical unit (also referred to as the first physical unit), the memory management circuit 51 may query the sorting information to obtain the usage sequence of the management tables 701(0) to 701(E). Taking FIG. 7 as an example, the sorting information may reflect that the usage priority of the current management table 701(0) is the highest. Therefore, the memory management circuit 51 may first determine the read voltage level 801(0) according to the information in the management table 701(0) and send a read command sequence to the rewritable non-volatile memory module 43 according to the read voltage level 801(0). The read command sequence may instruct the rewritable non-volatile memory module 43 to read data from the first physical unit by using the read voltage level 801(0).

In an exemplary embodiment, it is assumed that a threshold voltage distribution of multiple memory cells in the first physical unit includes states 810 and 820. The memory cells belonging to the state 810 are used to store a certain bit (or a bit combination). The memory cells belonging to the state 820 are used to store another bit (or another bit combination). For example, the memory cells belonging to the state 810 may be used to store bit “1” and/or the memory cells belonging to the state 820 may be used to store bit “0”, etc., which is not limited in the disclosure.

According to the received read command sequence, the rewritable non-volatile memory module 43 may set the read voltage level 801(0) as a target read voltage level and apply the read voltage level 801(0) to the memory cells in the first physical unit. If a certain memory cell may be conducted by the read voltage level 801(0) (for example, the threshold voltage of the memory cell is less than the read voltage level 801(0)), the memory management circuit 51 may judge that the memory cell belongs to the state 810. Conversely, if a certain memory cell is not conducted by the read voltage level 801(0) (for example, the threshold voltage of the memory cell is greater than the read voltage level 801 (0)), the memory management circuit 51 may judge that the memory cell belongs to the state 820. Thereby, the memory management circuit 51 may obtain data read from the first physical unit by using the read voltage level 801(0). For example, the data may reflect conducting states of the read voltage level 801(0) to the memory cells in the first physical unit. Then, the error detecting and correcting circuit 54 may decode the data. If the data may be successfully decoded, the error detecting and correcting circuit 54 may output the successfully decoded data.

If the data read by using the read voltage level 801(0) cannot be successfully decoded, the memory management circuit 51 may read the information in the management table 701(j) according to the sorting information. The memory management circuit 51 may determine the next read voltage level, that is, the read voltage level 801(j), according to the information in the management table 701(j). The memory management circuit 51 may send a read command sequence to the rewritable non-volatile memory module 43 according to the read voltage level 801(j). The read command sequence may instruct the rewritable non-volatile memory module 43 to read the data in the first physical unit by using the read voltage level 801(j). According to the read command sequence, the rewritable non-volatile memory module 43 may set the read voltage level 801(j) as the target read voltage level and apply the read voltage level 801(j) to the memory cells in the first physical unit. Thereby, the memory management circuit 51 may obtain data read from the first physical unit by using the read voltage level 801(j). The data may reflect conducting states of the read voltage level 801(j) to the memory cells in the first physical unit. Then, the error detecting and correcting circuit 54 may decode the data. If the data may be successfully decoded, the error detecting and correcting circuit 54 may output the successfully decoded data.

If the data read by using the read voltage level 801(j) cannot be successfully decoded, the memory management circuit 51 may read the information in the management table 701(i) according to the sorting information. The memory management circuit 51 may determine the next read voltage level, that is, the read voltage level 801(i), according to the information in the management table 701(i). Then, the memory management circuit 51 may send a read command sequence to the rewritable non-volatile memory module 43 according to the read voltage level 801(i). The read command sequence may instruct the rewritable non-volatile memory module 43 to read the data in the first physical unit by using the read voltage level 801(i). According to the read command sequence, the rewritable non-volatile memory module 43 may set the read voltage level 801(i) as the target read voltage level and apply the read voltage level 801(i) to the memory cells in the first physical unit. Thereby, the memory management circuit 51 may obtain data read from the first physical unit by using the read voltage level 801(i). The data may reflect conducting states of the read voltage level 801(i) to the memory cells in the first physical unit. Then, the error detecting and correcting circuit 54 may decode the data. By analogy, according to the management tables 701(0) to 701(E), the read voltage levels 801(0) to 801(E) may be sequentially used to read the data from the first physical unit.

In an exemplary embodiment, the decoding operation that may be repeatedly executed in the exemplary embodiment of FIG. 8 is also referred to as a hard decoding operation. The hard decoding operation may be used to repeatedly decode the data read from the first physical unit by using different read voltage levels until the management tables 701(0) to 701(E) are exhausted (that is, the number of executions of the decoding operation reaches a default number) or the read data is successfully decoded. It should be noted that the respective voltage positions of the read voltage levels 801(0) to 801(E), the total number of the read voltage levels 801(0) to 801(E), and the types of the states 810 and 820 of FIG. 8 are all examples and are not intended to limit the disclosure.

In an exemplary embodiment, it is assumed that the read voltage level 801(i) is set as the target read voltage level and is used to read data (also referred to as first data) from the first physical unit. In response to the read first data being successfully decoded, the memory management circuit 51 may update count information (also referred to as first count information) corresponding to the management table 701(i). For example, the first count information may reflect the number of times of the data read by using the read voltage level 801(i) being successfully decoded. In addition, if the first data is not successfully decoded (that is, the decoding corresponding to the first data fails), the memory management circuit 51 may not update the first count information.

After updating the first count information, the memory management circuit 51 may judge whether the first count information meets a default condition. In response to the first count information meeting the default condition, the memory management circuit 51 may increase the usage priority of the management table 701(i) in the management tables 701(0) to 701(E). However, if the first count information does not meet the default condition, the memory management circuit 51 may not change (that is, may maintain) the usage priority of the management table 701(i) in the management tables 701(0) to 701(E).

In an exemplary embodiment, the first count information includes a count value. In response to the read first data being successfully decoded, the memory management circuit 51 may update the count value, for example, update the count value from a current value (also referred to as a first value) to another value (also referred to as a second value). In particular, the second value is greater than the first value. For example, the memory management circuit 51 may add “1” to the first value to obtain the second value.

In an exemplary embodiment, the memory management circuit 51 may compare the updated count value (that is, the second value) with a threshold value. The threshold value is greater than zero. For example, the threshold value may be set to 5, 10, 20, etc., depending on practical requirements. In response to the updated count value (that is, the second value) being greater than the threshold value, the memory management circuit 51 may judge that the first count information meets the default condition. In addition, in response to the updated count value (that is, the second value) being not greater than the threshold value, the memory management circuit 51 may judge that the first count information does not meet the default condition.

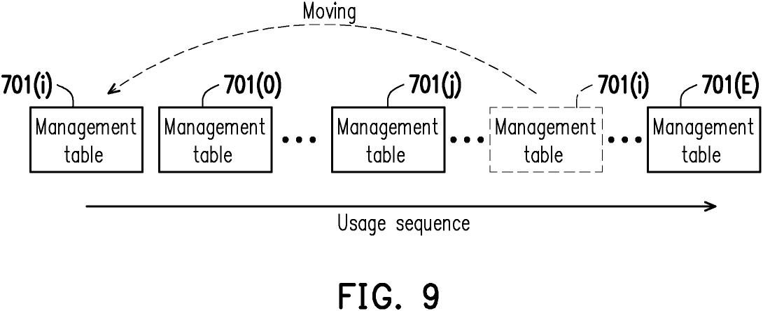

FIG. 9 is a schematic diagram of increasing a usage priority of a first voltage management table among multiple voltage management tables according to an exemplary embodiment of the disclosure. Please refer to FIG. 9. It is assumed that the management table 701(i) is the first voltage management table. In response to the first count information meeting the default condition, the memory management circuit 51 may update the sorting information of the management tables 701(0) to 701(E). For example, the memory management circuit 51 may increase the usage priority of the management table 701(i) to be higher than the usage priority of the management table 701(j) or 701(0). For example, the usage priority of the management table 701(i) may be increased to the highest or higher than the original usage priority of the management table 701(i). The adjusted usage sequence of the management tables 701(0) to 701(E) may be as shown in FIG. 9.

When it is necessary to determine the read voltage level for reading data according to the management tables 701(0) to 701(E) the next time, according to the updated sorting information, the management tables 701(0) to 701(E) may be sequentially used (for example, queried). Taking FIG. 9 as an example, the updated sorting information reflects that the usage priority of the management table 701(i) is the highest. Therefore, the management table 701(i) may be preferentially queried to determine the read voltage level 801(i), and the read voltage level 801(i) may be preferentially used to read data to be decoded. If the data read by using the read voltage level 801(i) may be successfully decoded, the successfully decoded data may be output.

However, if the data read by using the read voltage level 801(i) cannot be successfully decoded, the remaining read voltage levels (for example, the read voltage levels 801(0), 801(j), and 801(E)) may be sequentially determined and used according to the updated usage sequence of the management tables 701(0) to 701(E) until the management tables 701(0) to 701(E) are exhausted or the decoding is successful. The operation details of how to determine and use the read voltage level according to the usage sequence of the management tables 701(0) to 701(E) have been described in detail above and will not be repeated.

In an exemplary embodiment, adjusting (for example, increasing) the usage priority of the first voltage management table only when the first count information meets the default condition can improve the rigor of automatic adjustment of the usage sequence of multiple voltage management tables after the memory storage device 10 is shipped from the factory and delivered to the user. Thereby, the probability of executing meaningless or inappropriate adjustment of the voltage management table can be reduced.

In an exemplary embodiment, each of the management tables 701(0) to 701(E) corresponds to one count information, and an initial value of the count information is zero. Once data read by using a certain read voltage level is successfully decoded, the count information corresponding to the management table (for example, the management table 701(i)) for generating the read voltage level may be updated (for example, by adding “1” to the count value corresponding to the management table 701(i)).

In an exemplary embodiment, the memory management circuit 51 may also update (that is, adjust) the usage sequence of the management tables 701(0) to 701(E) according to a numerical distribution of the count information (that is, the count values) respectively corresponding to the management tables 701(0) to 701(E).

Taking FIG. 9 as an example, assuming that the count value corresponding to the management table 701(i) is greater than the count value corresponding to the management table 701(0), and the count value corresponding to the management table 701(0) is greater than the count value corresponding to the management table 701(j), the updated usage sequence of the management tables 701(0) to 701(E) may reflect that the usage priority of the management table 701(i) is higher than the usage priority of the management table 701(0), and the usage priority of the management table 701(0) is higher than the usage priority of the management table 701(j).

Alternatively, in an exemplary embodiment, if the count value corresponding to the management table 701(i) is between the count value corresponding to the management table 701(0) and the count value corresponding to the management table 701(j), the updated usage sequence of the management tables 701(0) to 701(E) may reflect that the usage priority of the management table 701(i) is between the usage priority of the management table 701(0) and the usage priority of the management table 701(j).

In an exemplary embodiment, the memory management circuit 51 may detect a specific system event. For example, the system event may include one of the rewritable non-volatile memory module 43 being powered on again (for example, rebooted), the temperature of the rewritable non-volatile memory module 43 reaching a temperature threshold value, and a deterioration evaluation value of the rewritable non-volatile memory module 43 reaching a deterioration threshold value. In response to the system event, the memory management circuit 51 may reset the count information (containing the first count value) corresponding to each management table, for example, reset the count information corresponding to each management table to zero. Thereafter, during an operation process of the memory storage device 10, the count information corresponding to each management table may be continuously updated.

In an exemplary embodiment, the deterioration evaluation value of the rewritable non-volatile memory module 43 may reflect the degree of deterioration of the rewritable non-volatile memory module 43. For example, the deterioration evaluation value of the rewritable non-volatile memory module 43 may be obtained according to various parameter values that may reflect the degree of deterioration of the rewritable non-volatile memory module 43, such as an (average) erase count, an (average) program count, an (average) read count, and /or an (average) bit error rate. The (average) erase count may reflect an (average) number of erasing of at least one physical unit in the rewritable non-volatile memory module 43. The (average) program count may reflect an (average) number of programming of at least one physical unit in the rewritable non-volatile memory module 43. The (average) read count may reflect an (average) number of reading of at least one physical unit in the rewritable non-volatile memory module 43. The (average) bit error rate may reflect an (average) bit error rate of at least one physical unit in the rewritable non-volatile memory module 43.

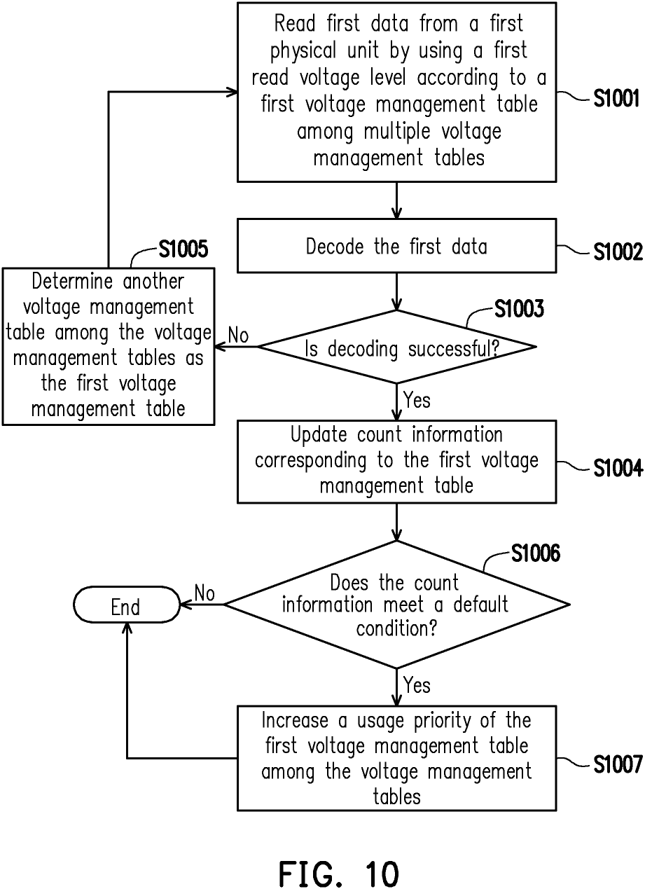

FIG. 10 is a flowchart of a table sorting method according to an exemplary embodiment of the disclosure. Please refer to FIG. 10. In Step S1001, first data is read from a first physical unit by using a first read voltage level according to a first voltage management table among multiple voltage management tables. In Step S1002, the first data is decoded. In Step S1003, whether the first data is successfully decoded is judged. In response to the first data being successfully decoded, in Step S1004, count information corresponding to the first voltage management table is updated. Alternatively, if the first data is not successfully decoded, in Step S1005, another voltage management table among the voltage management tables is determined as the first voltage management table, and Step S1001 is repeated.

After updating the count information corresponding to the first voltage management table, in Step S1006, whether the updated count information meets a default condition is judged. In response to the count information meeting the default condition, in Step S1007, a usage priority of the first voltage management table among the voltage management tables is increased. In addition, if the count information does not meet the default condition, the usage priority of the first voltage management table may not be updated.

However, each step in FIG. 10 has been described in detail as above and will not be repeated. It should be noted that each step in FIG. 10 may be implemented as multiple program codes or circuits, which is not limited in the disclosure. In addition, the method of FIG. 10 may be used in conjunction with the above exemplary embodiments or may also be used alone, which is not limited in the disclosure.

In summary, in the exemplary embodiments of the disclosure, the usage sequence of the voltage management tables in the decoding operation or the data reading operation can be dynamically adjusted, thereby increasing the efficiency of data decoding in the future. In particular, through increasing the usage priority of the voltage management table only when the count information corresponding to the voltage management table meets the default condition, the probability of executing meaningless or inappropriate adjustment can be effectively reduced.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A table sorting method, used for a rewritable non-volatile memory module, wherein the rewritable non-volatile memory module comprises a plurality of physical units, and the table sorting method comprises:
reading first data from a first physical unit among the physical units by using a first read voltage level according to a first voltage management table among a plurality of voltage management tables;
decoding the first data;
in response to the first data being successfully decoded, updating first count information corresponding to the first voltage management table; and
in response to the first count information meeting a default condition, increasing a usage priority of the first voltage management table among the voltage management tables.

2. The table sorting method according to claim 1, wherein the first count information reflects a number of times of data read by using the first read voltage level being successfully decoded.

3. The table sorting method according to claim 1, wherein the first count information comprises a count value, and the step of in response to the first data being successfully decoded, updating the first count information corresponding to the first voltage management table comprises:
updating the count value from a first value to a second value, wherein the second value is greater than the first value.

4. The table sorting method according to claim 1, wherein the first count information comprises a count value, and the table sorting method further comprises:
comparing the count value with a threshold value, wherein the threshold value is greater than zero; and
in response to the count value being greater than the threshold value, judging that the first count information meets the default condition.

5. The table sorting method according to claim 1, wherein the step of increasing the usage priority of the first voltage management table among the voltage management tables comprises:
increasing the usage priority of the first voltage management table among the voltage management tables to be higher than a usage priority of a second voltage management table among the voltage management tables.

6. The table sorting method according to claim 1, further comprising:
in response to a system event, resetting the first count information,
wherein the system event comprises one of the rewritable non-volatile memory module being powered on again, a temperature of the rewritable non-volatile memory module reaching a temperature threshold value, and a deterioration evaluation value of the rewritable non-volatile memory module reaching a deterioration threshold value.

7. A memory storage device, comprising:
a connection interface unit, used to couple to a host system;
a rewritable non-volatile memory module, wherein the rewritable non-volatile memory module comprises a plurality of physical units; and
a memory control circuit unit, coupled to the connection interface unit and the rewritable non-volatile memory module,
wherein the memory control circuit unit is used to:
read first data from a first physical unit among the physical units by using a first read voltage level according to a first voltage management table among a plurality of voltage management tables;
decode the first data;
in response to the first data being successfully decoded, update first count information corresponding to the first voltage management table; and
in response to the first count information meeting a default condition, increase a usage priority of the first voltage management table among the voltage management tables.

8. The memory storage device according to claim 7, wherein the first count information reflects a number of times of data read by using the first read voltage level being successfully decoded.

9. The memory storage device according to claim 7, wherein the first count information comprises a count value, and the operation of in response to the first data being successfully decoded, updating the first count information corresponding to the first voltage management table comprises:
updating the count value from a first value to a second value, wherein the second value is greater than the first value.

10. The memory storage device according to claim 7, wherein the first count information comprises a count value, and the memory control circuit unit is further used to:
compare the count value with a threshold value, wherein the threshold value is greater than zero; and
in response to the count value being greater than the threshold value, judge that the first count information meets the default condition.

11. The memory storage device according to claim 7, wherein the operation of increasing the usage priority of the first voltage management table among the voltage management tables comprises:
increasing the usage priority of the first voltage management table among the voltage management tables to be higher than a usage priority of a second voltage management table among the voltage management tables.

12. The memory storage device according to claim 7, wherein the memory control circuit unit is further used to:
in response to a system event, reset the first count information,
wherein the system event comprises one of the rewritable non-volatile memory module being powered on again, a temperature of the rewritable non-volatile memory module reaching a temperature threshold value, and a deterioration evaluation value of the rewritable non-volatile memory module reaching a deterioration threshold value.

13. A memory control circuit unit, comprising:
a host interface, used to couple to a host system;
a memory interface, used to couple to a rewritable non-volatile memory module, wherein the rewritable non-volatile memory module comprises a plurality of physical units;
a decoding circuit; and
a memory management circuit, coupled to the host interface, the memory interface, and the decoding circuit,
wherein the memory management circuit is used to read first data from a first physical unit among the physical units by using a first read voltage level according to a first voltage management table among a plurality of voltage management tables,
the decoding circuit is used to decode the first data,
in response to the first data being successfully decoded, the memory management circuit is further used to update first count information corresponding to the first voltage management table, and
in response to the first count information meeting a default condition, the memory management circuit is further used to increase a usage priority of the first voltage management table among the voltage management tables.

14. The memory control circuit unit according to claim 13, wherein the first count information reflects a number of times of data read by using the first read voltage level being successfully decoded.

15. The memory control circuit unit according to claim 13, wherein the first count information comprises a count value, and the operation of in response to the first data being successfully decoded, updating the first count information corresponding to the first voltage management table comprises:
updating the count value from a first value to a second value, wherein the second value is greater than the first value.

16. The memory control circuit unit according to claim 13, wherein the first count information comprises a count value, and the memory management circuit is further used to:
compare the count value with a threshold value, wherein the threshold value is greater than zero; and
in response to the count value being greater than the threshold value, judge that the first count information meets the default condition.

17. The memory control circuit unit according to claim 13, wherein the operation of increasing the usage priority of the first voltage management table among the voltage management tables comprises:
increasing the usage priority of the first voltage management table among the voltage management tables to be higher than a usage priority of a second voltage management table among the voltage management tables.

18. The memory control circuit unit according to claim 13, wherein the memory management circuit is further used to:
in response to a system event, reset the first count information,
wherein the system event comprises one of the rewritable non-volatile memory module being powered on again, a temperature of the rewritable non-volatile memory module reaching a temperature threshold value, and a deterioration evaluation value of the rewritable non-volatile memory module reaching a deterioration threshold value.
